(19) United States
(12) Patent Application Publication
(10) Pub. No.: US 2025/0282279 A1
(43) Pub. Date: Sep. 11, 2025

(54) QUICK HOLD AND RELEASE CLAMP AND METHOD OF RELEASABLY JOINING A FIRST AND SECOND BODY USING SAME

(71) Applicants: KAWASAKI MOTORS, LTD., Akashi-shi (JP); SOUCY INTERNATIONAL Inc., Drummondville (CA)

(72) Inventors: Justin OLSON, Lincoln, NE (US); Brian BUTLER, Lincoln, NE (US); Keiji TAKAHASHI, Lincoln, NE (US); Dominique BOUDREAU, Drummondville (CA); Frédérik BESSETTE, Drummondville (CA); Jean-Michel LECLERC, Drummondville (CA); Alexandre POUDRIER, Drummondville (CA)

(73) Assignees: KAWASAKI MOTORS, LTD., Akashi-shi (JP); SOUCY INTERNATIONAL Inc., Drummondville (CA)

(21) Appl. No.: 18/798,859

(22) Filed: Aug. 9, 2024

Related U.S. Application Data
(60) Provisional application No. 63/561,942, filed on Mar. 6, 2024.

(51) Int. Cl. B60P 7/08; F16B 2/18

(52) U.S. Cl. CPC B60P 7/0807; F16B 2/18

(57) ABSTRACT

A releasable clamp, a method for releasably joining a first body to a second body and an actuator are provided. A clamp may be insertable through aligned openings in joinable bodies. The clamp may comprise a base comprising a compression surface facing the first body and being compressible around a periphery of the first opening, and a protrusion extending in a longitudinal direction from the base and insertable through the aligned openings. A force may be applied to an actuator operatively connected to a retractable pawl or pawls housed in the base and extendable in a lateral direction perpendicular to the longitudinal direction. When the pawl or pawls are extended to an engaged position, the second body, the first body and the base are held into compressed relation against the compression surface. A sloped surface on the pawl or pawls allows the clamp to secure joinable bodies of various thicknesses.

### TECHNICAL FIELD

The present disclosure relates to a releasable clamp by which a first body such as an accessory body can be quickly attached to and released from a second body, such as a vehicle body.

### BACKGROUND ART

Recreational and work vehicles continue to grow in popularity for transporting people to sometimes remote destinations over rugged terrain for the purpose of engaging in outdoor leisure or work activities. Quite often, these activities involve an extensive range of equipment, such as bicycling equipment, camping equipment, hunting equipment, and/or work equipment. Such equipment may be carried in containers or racks, or other structures referred to herein generally as “accessories,” in the vehicle.

In order to ensure that these accessories remain attached to the vehicle, a means is required to secure these accessories to the vehicle. However, difficulties may arise in that depending on the manufacturer of the accessories and/or of the vehicle, the bodies of the accessories and the vehicle may have widely varying thicknesses, and no clear position in which to place the mounting mechanisms, making it difficult to create a mechanism that is widely adaptable across a wide range of accessory and vehicle bodies thicknesses.

Various mechanism designs have been attempted such as screw-type fasteners, (see Patent Document 1: U.S. Patent Application Publication No. 2011/0020092); and snap type fasteners (see Patent Document 2: U.S. Patent Application Publication No. 2013/0287517 and Patent Document 3: U.S. Patent Application Publication No. 2017/0335877) as examples. However, conventional approaches have suffered drawbacks in that they are difficult to deploy, lack the strength to accommodate heavier accessories, are prone to breakage, are subject to slippage or engagement failure, or fail to provide a secure engagement between the body of the vehicle and the body of the accessory (e.g. to prevent rattling or vibration), and other drawbacks attributable, at least in part, to the inability to meaningfully accommodate different body thicknesses of the accessory and the vehicle bodies.

For example, in Patent Document 1, a panel fastener is provided with an actuator pin and a retainer mechanism. The fastener arrangement in Patent Document 1 requires a tool to turn knob 10, or knob 10 may be rotated by hand in order to rotate a pin 11 to engage flange 16 at a fixed depth. However, according to the arrangement in Patent Document 1, it may be difficult to accommodate panels having varying thicknesses.

In the two-piece clip described in Patent Document 2, an engagement convex portion may include a pin that is pushed into a grommet of a fixed length body portion to a maximum push-in position that enables the sides of the body portion to engage the walls of an insertion hole. However, according to the arrangement in Patent Document 2, it may be difficult to accommodate different depths in the bodies in which a hole is formed. Further, since the body is made of resin, it is likely to be easily breakable when exposed to shear forces that may be experienced in a vehicular application. The fastening clip assembly described in Patent Document 3 may suffer similar drawbacks.

### SUMMARY

In view of the above and other drawbacks of conventional arrangements, one or more embodiments are provided for a quick hold and release clamp and a method of releasably joining a first body to a second body using a clamp.

In an embodiment or embodiments, a clamp may be provided for releasably joining a first body to a second body. The clamp may be insertable through a first opening in the first body and a second opening in the second body aligned with the first opening. The clamp may comprise: a base comprising a compression surface that faces the first body and is compressible around a periphery of the first opening, and a protrusion extending in a longitudinal direction from the base, the protrusion insertable through the first and second openings and connectable to the second body; an actuator connected to the base; and a retractable pawl assembly housed in the base, the pawl assembly having a pawl or pawls extendable from the protrusion of the base in a lateral direction perpendicular to the longitudinal direction, the pawl assembly operatively coupled to the actuator. In an embodiment or embodiments, the pawl or pawls may be retracted into the protrusion in a disengaged position by operation of the actuator through a force applied to the actuator. The pawl or pawls may be extended from the protrusion of the base to an engaged position to engage the second body and to hold the second body, the first body and the base into compressed relation against the compression surface by force applied to the actuator. It will be appreciated that the pawl or pawls may extend from and retract into the protrusion in a direction orthogonal to the rotation axis, e.g. may be retracted to release the engagement. Each of the pawl or pawls may comprise a cam surface that slopes to widen in a direction away from the base to variably engage with the second body. The cam surface may extend to variably engage the second body to hold the second body, the first body and the base into compressed relation against the compression surface, e.g. despite variations in thicknesses between bodies being joined.

The base may further comprise resilient members coupled to the actuator at one end and extending laterally from a central axis of the base in the longitudinal direction, the resilient members pressing against the pawl or pawls at an other end to urge the pawl or pawls to extend laterally outwardly by operation of the actuator.

In an embodiment or embodiments, a clamp for releasably joining a first body to a second body may be provided. The clamp may be insertable through a first opening in the first body and a second opening in the second body aligned with the first opening. The clamp may comprise a base having a compression surface; a protrusion projecting from the base in a longitudinal direction perpendicular to the compression surface relative to the base; a retractable pawl that can be switched between a first state of being housed in the protrusion and a second state of extending from the protrusion in a lateral direction perpendicular to the longitudinal direction; and an actuator that transmits power to the retractable pawl for switching the state of the retractable pawl from one of the first and second states to the other one of the first and second states in response to an operation force. The retractable pawl may comprises a surface facing the base and that slopes away from the compression surface in the longitudinal direction, and the surface of the pawl widens in a lateral direction away from the base to engage with the opening of the second body to hold the second body against the first body, the first body and the base into compressed relation against the compression surface.

The base may further comprise a resilient member operatively coupled to the pawl at one end and extending laterally from the protrusion to press against the pawl at an other end to urge the pawl outwardly by the operational force. The laterally retractable pawl extends laterally from and retracts laterally into the protrusion in a direction orthogonal to the longitudinal direction.

One or more embodiments may further include a method of releasably joining a first body to a second body using a clamp comprising: a base having a compression surface; a protrusion projecting from the base in a longitudinal direction perpendicular to the compression surface relative to the base; a retractable pawl retractable into the base and comprising a surface; and an actuator that transmits power to the retractable pawl. The method may comprise inserting, with the retractable pawl in a first state of being retracted, the protrusion through a first opening in the first body and a second opening in the second body aligned with the first opening; and switching the state of the retractable pawl to a second state of being extended from the base in a lateral direction perpendicular to the longitudinal direction in response to the power transmitted by applying an operational force applied to the actuator. In the second state, the retractable pawl extends from the base to an engaged position to engage the second body and to hold the second body, the first body and the base into compressed relation against the compression surface. The method may further comprise switching the state of the retractable pawl from the second state in which the second body, the first body and the base are held in compressed relation against the compression surface to the first state in which the second body, the first body and the base are released from compressed relation such that the clamp is removed.

One or more embodiments may further include an actuator for engaging a releasable clamp for releasably joining a first body to a second body, the releasable clamp being insertable through a first opening in the first body and a second opening in the second body aligned with the first opening, the releasable clamp comprising: a base; a protrusion; a retractable pawl extendable and retractable along an engagement axis, the retractable pawl capable of being switched between a first state of being housed in the protrusion and a second state of extending from the protrusion. The actuator may comprise: an actuator body configured to be selectively rotatable about a first axis extending longitudinally, the actuator body extending along a second axis perpendicular to the first axis, the actuator body configured to activate operation of the releasable clamp under an activation force; a mounting portion operatively coupled to the base; a coupler operatively coupled to the actuator and extending radially from the first axis; and an internal mechanism operatively coupled to the actuator and the retractable pawl, the internal mechanism configured to convert the rotational movement of the actuator under the activation force about the first axis into a translational movement of the retractable pawl along the engagement axis. The internal mechanism may comprise: a connecting member pivotally connected to the coupler about a connecting pivot defining a connecting pivot axis extending parallel to the first axis, a resilient member provided between the connecting member and the pawl to bias the pawl away from the first axis, and a guiding member slidingly connected to and guiding the connecting member along the engagement axis. The actuator may be configured to transmit the activation force to the retractable pawl through the internal mechanism, the actuator may switch the state of the retractable pawl from one of a first state in which the pawl is extended and a second state in which the pawl is retracted to the other one of the first state and the second state in response to the activation force; and the retractable pawl comprises an engagement surface facing the base and that slopes away in the longitudinal direction from a compression surface of the base. The engagement surface of the retractable pawl widens in a lateral direction away from the base. When the engagement surface comes into contact with a peripheral portion of the first and second openings of the first and second bodies, respectively, the releasable clamp provides a clamping force adaptative to various thicknesses among the first and second bodies to be joined. When the activation force is applied to the actuator such that the retractable pawl is in the second state, the resilient member applies the biasing force so as to maintain an over-center effect between the coupler and the connecting member that prevents unwanted release of the releasable clamp. The actuator may be configured so as to be operable without use of a tool, e.g. the forces applied by actuator, the arrangement of the connecting member, the pawls, and the configuration of the resilient members, and so on, may be such that secure grip may be provided by application of a hand-force to the actuator.

One or more embodiments may still further provide a releasable clamp for releasably joining a first body to a second body, the releasable clamp being insertable through a first opening in the first body and a second opening in the second body aligned with the first opening. The releasable clamp may comprise: a base; a protrusion; a retractable pawl extendable and retractable along an engagement axis, the retractable pawl capable of being switched between a first state of being housed in the protrusion and a second state of extending from the protrusion; and an actuator in accordance with various embodiments discussed above. The actuator may be configured to transmit the activation force to the retractable pawl through the internal mechanism so as to switch the state of the retractable pawl from one of the first state and the second state to the other one of the first state and the second state in response to the activation force.

### BRIEF DESCRIPTION OF DRAWINGS

FIG. 1 is a perspective diagram illustrating a side view of a releasable clamp in accordance with one or more embodiments in which a pawl or pawls are in an extended state;

FIG. 2 is a perspective diagram illustrating a side view of a releasable clamp in accordance with one or more embodiments in which a pawl or pawls are being extended or retracted;

FIG. 3 is a perspective diagram illustrating a side view of a releasable clamp in accordance with one or more embodiments in which a pawl or pawls are in a retracted state;

FIG. 4 is a perspective diagram illustrating a top view of components of a base of a clamp in accordance with one or more embodiments including resilient members;

FIG. 5 is a perspective diagram illustrating an exploded view including components of a releasable clamp in accordance with one or more embodiments including a base, an actuator, pawl or pawls, resilient members and a protruding portion;

FIG. 6 is a partial perspective diagram illustrating a view of an assembly including a first body, such as an accessory, which may be mounted to a second body, such as a vehicle body, using a releasable clamp in accordance with one or more embodiments;

FIG. 7 is a partial perspective diagram illustrating view of a first opening in a first body aligned with a second opening in a second body through which a releasable clamp may be insertable in accordance with one or more embodiments;

FIG. 8 is a partial perspective diagram illustrating view of the first opening in the first body aligned with the second opening in the second body of the FIG. 7 through which a releasable clamp is inserted in accordance with one or more embodiments;

FIG. 9A is a perspective diagram illustrating a side view of a releasable clamp in a second state in which a pawl or pawls are extended in accordance with one or more embodiments;

FIG. 9B is a diagram illustrating a top view of the releasable clamp of FIG. 9A;

FIG. 9C is a diagram illustrating a side view the releasable clamp of FIG. 9A;

FIG. 9D is a diagram illustrating an end front view of the releasable clamp of FIG. 9A;

FIG. 9E is a diagram illustrating a bottom view of the releasable clamp of FIG. 9A;

FIG. 10A is a perspective diagram illustrating a cross-sectional perspective view of the releasable clamp of FIG. 9A taken along section line AA-AA shown in FIG. 9A;

FIG. 10B is a diagram illustrating a cross-sectional view of the releasable clamp of FIG. 9A taken along section line E-E shown in FIG. 9B;

FIG. 10C is a diagram illustrating a cross-sectional view of the releasable clamp of FIG. 9A taken along section line E-E shown in FIG. 9B;

FIG. 10D is a diagram illustrating a cross-sectional view of the releasable clamp of FIG. 9A taken along section line F-F shown in FIG. 9B;

FIG. 10E is a diagram illustrating a cross-sectional view of the releasable clamp of FIG. 9A taken along section line G-G shown in FIG. 9B;

FIG. 10F is a diagram illustrating a cross-sectional view of the releasable clamp of FIG. 9A taken along section line H-H shown in FIG. 9B;

FIG. 10G is a diagram illustrating a cross-sectional view of the releasable clamp of FIG. 9A taken along section line J-J shown in FIG. 9B;

FIG. 11A is a perspective diagram illustrating a side view of a releasable clamp in an intermediate state in which a pawl or pawls are between being retracted and extended by operation of an actuator in accordance with one or more embodiments;

FIG. 11B is a diagram illustrating a top view of the releasable clamp of FIG. 11A;

FIG. 11C is a diagram illustrating a side view of the releasable clamp of FIG. 11A;

FIG. 12A is a perspective diagram illustrating a cross-sectional perspective view of the releasable clamp of FIG. 11A taken along section C-C shown in FIG. 11B;

FIG. 12B is a diagram illustrating a cross-sectional side view of the releasable clamp of FIG. 11A taken along section C-C shown in FIG. 11B;

FIG. 13A is a perspective diagram illustrating a side view of a releasable clamp in a first state in which a pawl or pawls are retracted into a protrusion by operation of an actuator in accordance with one or more embodiments;

FIG. 13B is a diagram illustrating a side top view of the releasable clamp of FIG. 13A;

FIG. 13C is a diagram illustrating a side view of the releasable clamp of FIG. 13A;

FIG. 13D is a diagram illustrating a front view of the releasable clamp of FIG. 13A;

FIG. 14A is a perspective diagram illustrating a cross-sectional perspective view of the releasable clamp of FIG. 13A taken along section line D-D shown in FIG. 13B;

FIG. 14B is a diagram illustrating a cross-sectional side view of the releasable clamp of FIG. 13A taken along section line D-D shown in FIG. 13B; and

FIG. 15 is a flow diagram illustrating a method of releasably attaching a first body to a second body with a releasable clamp in accordance with one or more embodiments.

### DETAILED DESCRIPTION

Descriptions are provided herein below for one or more embodiments based on the drawings. In the respective drawings referenced herein, the same constituents are designated by the same reference numerals and a duplicate explanation concerning the same constituents is omitted for brevity. All of the drawings are provided to illustrate the respective examples only.

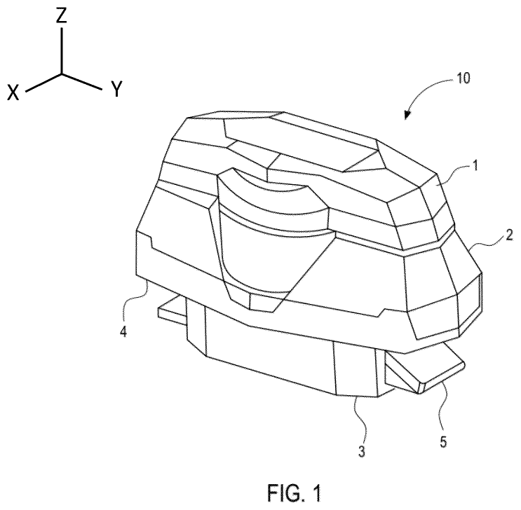

A perspective view of a releasable clamp 10 in accordance with one or more embodiments is shown in FIG. 1. The releasable clamp 10 may include an actuator 1, a base 2, a protrusion 3, a compression surface 4 and a pawl or pawls 5.

The various components of the releasable clamp 10 will be described in accordance with an exemplary embodiment of the releasable clamp 10 having a single instance of each of the various components (e.g. pawl 5) for sake of brevity. It is understood that the described embodiment is illustrative and exemplary only and is not to be considered as limiting the scope of the invention. For example, more than one pawl 5 may be present and operatively connected to other components of the releasable clamp 10, as shown in the drawings. Indeed, more or less instances of some components or features of the releasable clamp 10 may be necessary to adapt the releasable clamp 10 accordingly, as shown in the drawings.

As can be seen in FIG. 1, the protrusion 3 may protrude from the base 2 in a longitudinal direction, which may be referred to as a Z direction, assuming that the compression surface 4 is generally aligned in an X-Y plane. The longitudinal direction may correspond generally to an insertion direction of the releasable clamp into an aligned pair of openings (i.e. a vehicle opening and an accessory opening), referred to as an operating position, as will be described in greater detail hereinafter. It will be understood that practically speaking, the protrusion 3 may be aligned at various angles during insertion provided the general alignment enables insertion of the protrusion 3 into the pair of openings.

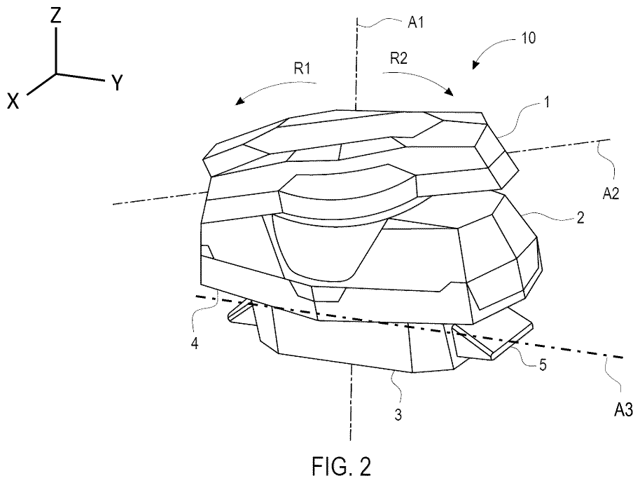

The arrangement of the releasable clamp 10 may be further understood with reference to FIG. 2, which illustrates the actuator 1, the base 2, the protrusion 3, the compression surface 4 and the pawl 5 relative to axes A1, A2 and A3.

### Actuator

The actuator 1 has an actuator body 1b configured to be selectively rotatable about a first axis A1, which may be a central axis that corresponds to a longitudinal axis that extends through the center of the clamp 10, and that extends along a second axis A2, which may be a lengthwise axis generally perpendicular to the first axis A1 and generally aligned in the X-Y plane. By providing the actuator 1 that extends outwardly from the first axis A1 along the second axis A2, a force may be selectively applied to the actuator 1 in order to activate operation of the clamp 10, as will be described in greater detail below. In some embodiments, the releasable clamp 10 is configured such that the actuator 1 can be conveniently operated by an average human applying a reasonable amount of force. Stated differently, the releasable clamp 10 is intended to be a quick-release and hold clamp that does not require use of a tool to operate, but rather only application of a force to the actuator 1.

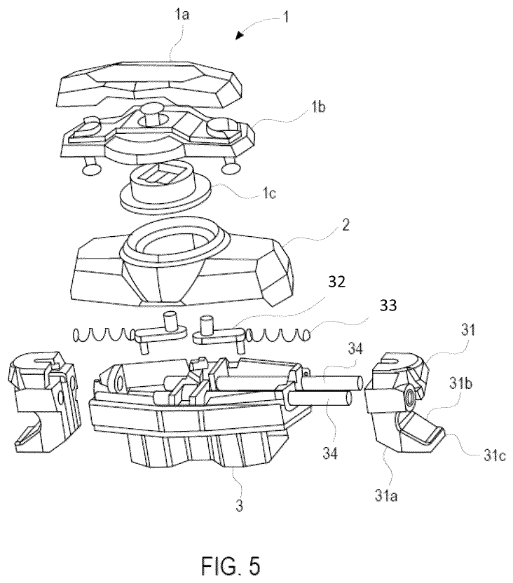

As can be seen in the exploded view provided in FIG. 5, the actuator 1 may include a cover or top surface 1a which may be primarily designed for ergonomical purposes and may also contain promotional or instructional information integrated thereon. The top surface 1a may also be provided as a strengthening or structural component, such as by being made of a highly durable material or a metallic material to reduce wear thereof and consequences of contact/impact with equipment, and withstand shock from dropping and other potential use-related damage.

The top surface 1a may also serve to prevent the unwanted disassembly of the clamp 10. In some cases the top surface 1a may accommodate a key-receiving portion of a locking mechanism (not shown) preventing unwanted actuation of the clamp 10.

The actuator 1 may further include a mounting portion 1f to which the top surface 1a may be mounted and that may enable the actuator 1 to be coupled to the base 2.

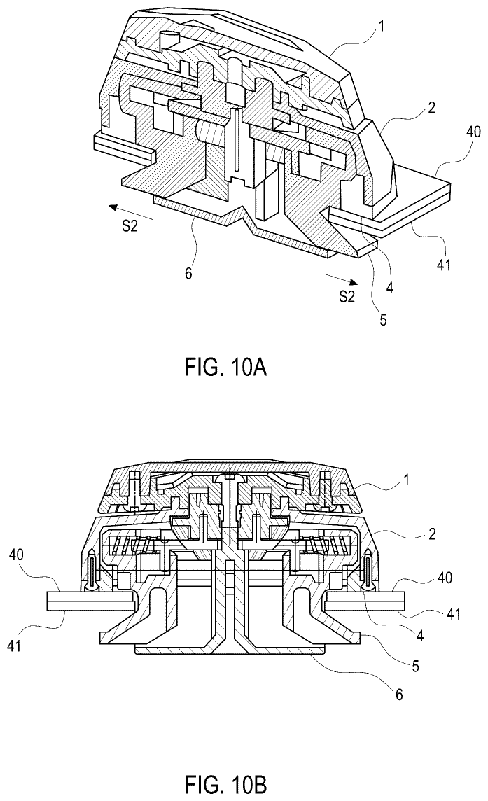

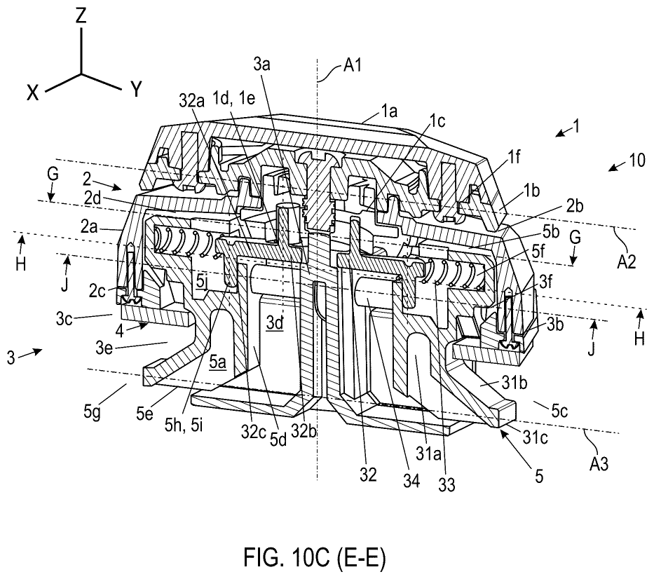

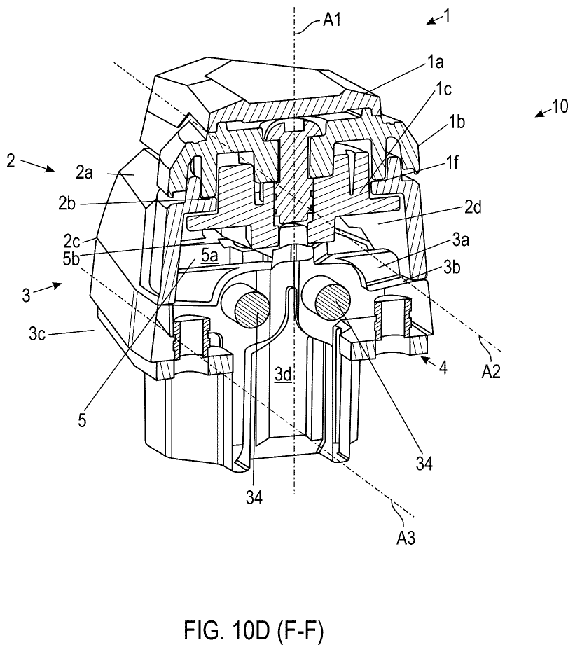

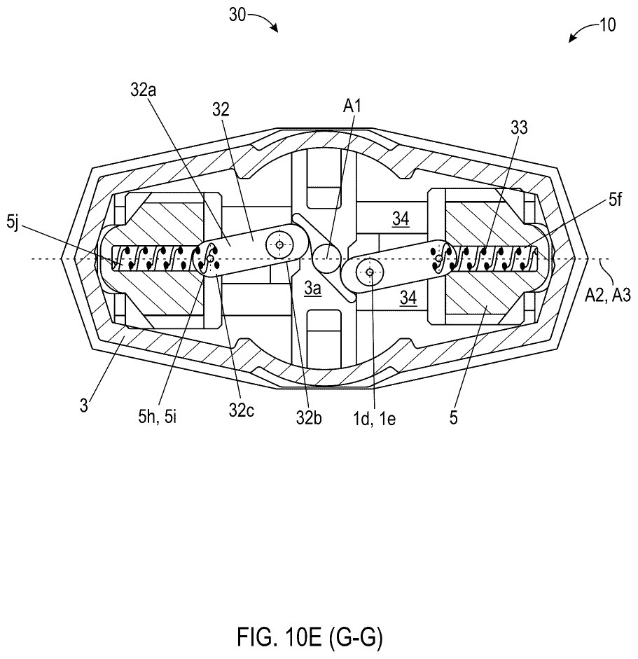

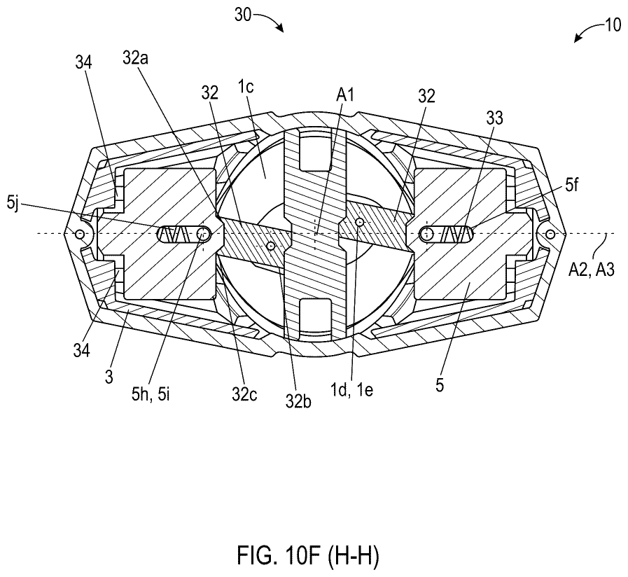

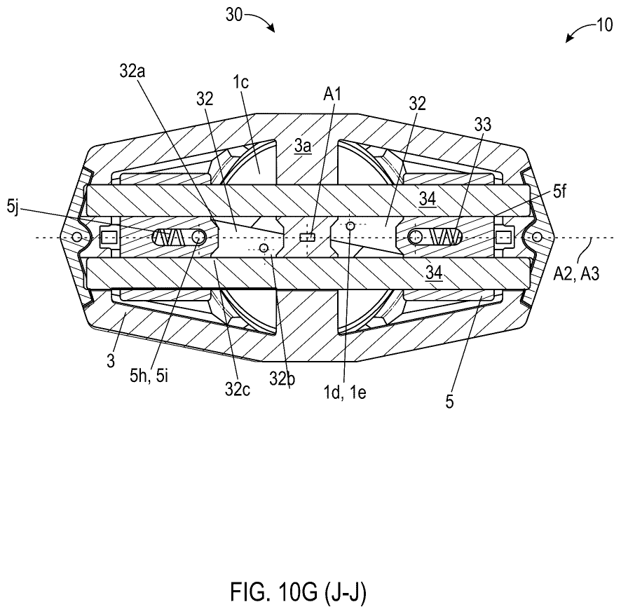

In addition, the actuator 1 may further include a crank portion or coupler 1c extending radially from the first axis A1. As best seen in FIG. 10C, the coupler 1c has a connecting pivot 1d defining a connecting pivot axis 1e extending parallel to the first axis A1. In some embodiments, the coupler 1c may be a component separate from the actuator 1 and operatively connected to the actuator 1.

### Base

The base 2 has a base body 2a defining a top surface 2b connectable to the actuator 1 and including an opening to receive a portion of the actuator 1, a bottom surface 2c opposite the top surface 2b and connectable to the protrusion 3, and a base housing portion 2d configured to receive at least partially some of the components of the releasable clamp 10, as will be described in greater detail below.

### Protrusion

The protrusion 3 has a protrusion body 3a defining a top surface 3b connectable with the bottom surface 2c of the base 2, a bottom surface 3c including the compression surface 4 and a protruding portion 3d extending outwardly along the first axis A1 and having an opening 3e facing the third axis A3, and a protrusion housing portion 3f configured to receive at least partially some of the components of the releasable clamp 10, as will be described in greater detail below.

### Internal Mechanism

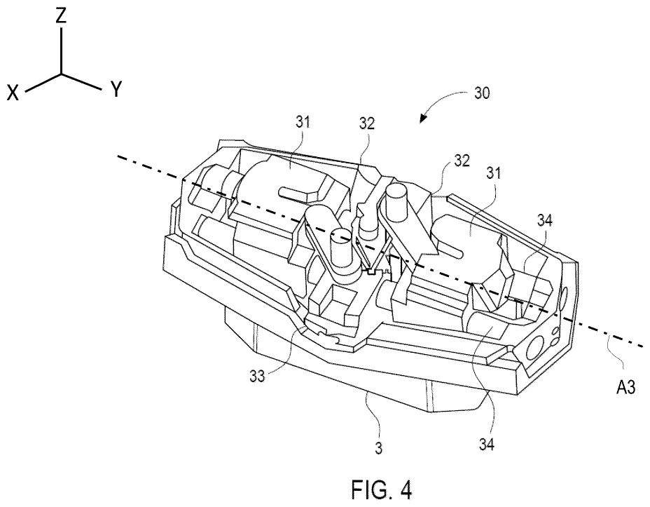

An exposed view of the protrusion 3 is provided in FIG. 4, with the base 2 and the actuator 1 being hidden for sake of clarity. Referring also to FIG. 5, broadly speaking, the actuator 1 is operatively connected to the pawl 5 via an internal mechanism 30 configured to convert the rotational movement of the actuator 1 about the first axis A1 into a translational movement of the pawl 5 along the third axis A3.

The internal mechanism 30 will now be described. The internal mechanism 30 includes a connecting member 32, a resilient member 33, and a guiding means 34, and is operatively connected to the actuator 1 and the pawl 5, as will be described in detail herein after.

### Pawl

The pawl 5 has a pawl body 5a having a top portion 5b, a front portion 5c facing away the first axis A1, a rear portion 5d opposite the front portion 5c, and a bottom portion 5e.

The pawl body 5a defines a cavity 5f configured to receive at least partially the connecting member 32 and the resilient member 33. As best seen in FIG. 10C, the cavity 5f further includes an elongated portion 5j extending downwardly and away from the first axis A1.

The bottom portion 5e includes a hook portion 5g extending in a direction parallel to the third axis A3 and away from the first axis A1, and being configured to be insertable into the pair of openings when the releasable clamp 10 is in the first state S1 and to apply a clamping force behing the vehicle opening toward the compression surface 4 when the releasable clamp 10 is in the second state S2.

The pawl body 5a may be provided with a biasing abutment portion 31 within the housing portion 2d of the base 2 that receives at least partially some of the components of the protrusion 3 that enable operation of the pawl 5. The biasing abutment portion 31 may be slidable along the guiding means 34 to extend or retract relative to the protrusion 3, via the internal mechanism 30 pivotally connected to the actuator 1 on a first end thereof about a first pivot and may pivotally connect, on a second end thereof, to the biasing abutment portion 31 of the pawl 5 operated thereby about a second pivot.

As the actuator 1 is moved in one of the first direction R1 and the second direction R2, the force from the actuator 1 is transferred through the internal mechanism 30 to a pushing or pulling force that pushes or pulls on the biasing abutment portion 31 to slide the biasing abutment portion 31 along the guiding means 34 to extend or retract the pawl 5. More precisely, as the actuator 1 is activated, the coupler 1c transfers the operational forces applied to the actuator 1 to the biasing levers 32 in order to urge the pawl 5 into an engaged or disengaged position.

As can be seen in FIG. 5 and FIG. 10C, the biasing abutment portion 31 may include a projecting pawl portion 31a that projects in the longitudinal (insertion) direction, a sloping engagement face 31b. As the pawl 5 is extended from the protrusion 3, such as by operation of the actuator 1 as described above, the sloping engagement face 31b may come into contact with a body portion, more specifically a peripheral portion of the opening of the body portion as will be further described below, (e.g. a vehicle body), to which another body (e.g. an accessory body) is being joined by the releasable clamp 10. Due to the sloped aspect of the sloping engagement face 31b of the pawl 5, the releasable clamp 10 still provides a secure grip notwithstanding the variations of thicknesses among the first and second bodies to be joined. In other words, it can be said that the clamp 10 is configured to provide a clamping force adaptative to various thicknesses of body portions to be joined. The pawl or pawls 5 may also include other features such as a gripping ridge 31c that may assist in avoiding slippage of the clamp 10 once in operation.

The pawl body 5a further has a pawl pivot 5h defining a pawl pivot axis 5i extending parallel to the first axis A1. In this embodiment, the pawl pivot axis 5i is movable in the elongated portion 5j of the cavity 5f away from the first axis A1.

The pawl body 5a is operatively connected to the guiding means 24 aligned with the third axis A3 such that the pawl 5 moves or slides according to a translational movement along the guiding means 24.

### Guiding Means

In the present embodiment, the guiding means 24 is a circular rod extending parallel to the third axis A3. The pawl body 5a therefore has an opening configured to receive and slide along the guiding means 24. In other embodiments, the guiding means 24 can be a rail, a notch, or any equivalent linear guiding feature, and the pawl body 5a can thus be adapted to operatively connect to and slide along said variations of guiding means 24.

### Connecting Member

The connecting member 32 has an elondated body 32a having a first end 32b pivotally connected to the coupler 1c via the connecting pivot 1d and about the connecting pivot axis 1e, and a second end 32c pivotally connected to the pawl body 5a via the pawl pivot 5h and about the pawl pivot axis 5i.

In this exemplary embodiment, the connecting member 32 has a first protrusion extending longitudinally upwardly received in a cavity in the coupler 1c and therefore forming the connecting pivot 1d, and a second protrusion extending longitudinally downwardly received in the cavity 5f of the pawl 5 and therefore forming the pawl pivot 5h. Other equivalent configurations are contemplated to form pivotal connections between the pawl 5, the connecting member 32, and the coupler 1c.

In some embodiments, the connecting member 32 and the resilient member 33 may be integral and forming a biasing lever. The biasing lever may include a rigid portion 32 and a resilient portion 33, which, in some embodiments may include a spring.

### Resilient Member

The resilient member 33 is configured to bias the pawl 5 away from the first axis A1. The resilient member 33 may be a spring or any equivalent elastic part.

### Operation

In order to operate the releasable clamp 10, the actuator 1, which is oriented along the second axis A2, may be moved in various directions around the first axis A1, such as in a first direction R1 and in a second direction R2, by the application of a force thereto. Moving the actuator 1 around the first axis A1 results in moving the pawl or pawls 5 along a third axis A3 extending generally perpendicular to the first axis A1, as will be described in greater detail herein after. In some embodiments, R1 and R2 may refer to opposite directions of rotation, but the present technology is not so limited. For example, the actuator 1 may move in a single or multiple directions and may engage or disengage the clamp 10 in one or more directions of movement of the actuator 1. For example, in some embodiments, the operation of the actuator 1 in the first direction R1 and in the second direction R2 may enable the releasable clamp 10 to be switched between a disengaged state (first state, S1) and an engaged state (second state, S2) as will be described in greater detail herein after.

### Intermediate State

As illustrated in FIG. 2, the pawl or pawls 5 being at least partially extended along the third axis A3, the releasable clamp 10 may be in the second state or engaged state. It could be said that the clamp 10, as shown in FIG. 2, is in an intermediate state.

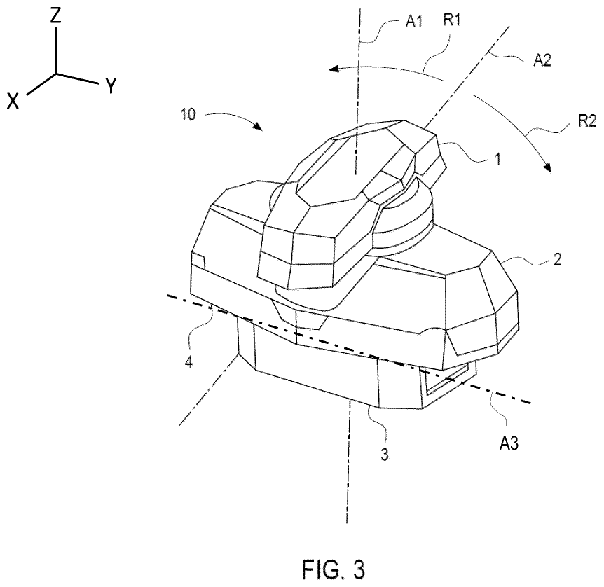

As the actuator 1 is further engaged for operation, such as by further movement of the actuator 1 in the first direction R1 or in the second direction R2, the first state or second state of the releasable clamp 10 may be further engaged as illustrated in FIG. 3.

Generally speaking, moving the actuator 1 toward further engaging one state will have the effect of disengaging the other state. That is, as the actuator 1 is moved toward the first state S1, the degree of holding or grip provided by the extension pawl or pawls 5 along the third axis A3 in the second state S2 is reduced. Conversely, as the actuator 1 is moved toward the second state S2, the degree of insertability or removability provided in the first state S1 is reduced.

### State S1

As illustrated in FIG. 3, the pawl or pawls 5 being fully retracted, the releasable clamp 10 may be considered to be in the first state S1 or disengaged state, ready for insertion or removal of the clamp 10 into or from the aligned pair of openings. It will be appreciated that the first state or fully retracted state as an initial undeployed state, allows easy insertion or removal of the releasable clamp 10 for operation as will be described in further detail herein after.

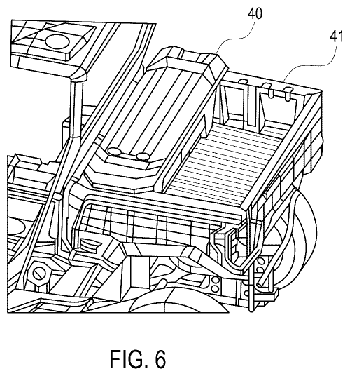

In accordance with one or more embodiments, as illustrated in FIG. 6, the releasable clamp 10 may be used to facilitate the attachment of a first body and a second body. Examples of a first body and a second body may include an accessory body 40 such as a utility caddy, as a first body, that may be secured in the bed of a vehicle body 41, as a second body, such as by attachment to a vehicle bed rail. It will be appreciated that, in many applications, the vehicle body 41 may be provided with openings to facilitate the attachment of various accessories such as tie-down straps and other uses. These openings may be used for the attachment of an accessory or other body in accordance with one or more embodiments by being alignable with a corresponding opening provided in the accessory or other body as will be described in greater detail herein after.

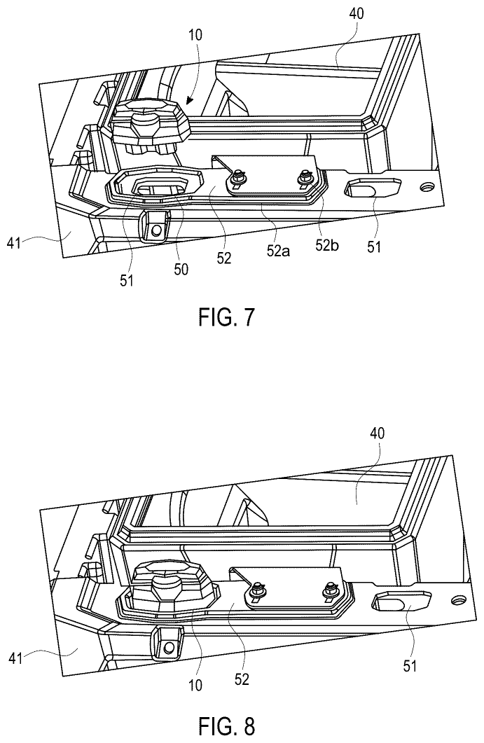

FIG. 7 illustrates an exemplary arrangement in which the releasable clamp 10 may be used to secure the accessory body 40 to the vehicle body 41. In the illustrated embodiment, an adapter 52 may be used to facilitate use of the releasable clamp 10. It will be understood that the adapter 52 may provide advantageous effects such as providing a standardized opening 50 for the accessory body 40 specific to the particular vehicle body 41, such that the accessory body 40 may be used with a variety of vehicle bodies 41 by simply changing the adapter 52. The adapter 52 may also be used to provide a seating template area for the compression surface 4 of the releasable clamp 10. The adapter 52 may be placed over one of the holes 51 present in, for example, a bed rail of the vehicle body 41. The adapter 52 may further be provided with a non-slip surface 52a placed between the bottom surface of the adapter 52 and the mounting surface of the vehicle body 41 to prevent or reduce rattling and slippage. The adapter 52 may further be provided with fasteners 52b that may allow the adapter 52 to be adjustably attached to a mounting flange of accessory body 40. FIG. 7 illustrates releasable clamp 10 in a position for insertion into the hole 50 of the accessory body 40 and the hole 51 of the vehicle body 41, which are aligned. Prior to insertion, it will be understood that the releasable clamp 10 should be placed in the first state, i.e. the state in which the pawl or pawls 5 are retracted into the protrusion 3 as described above, by applying an operating force to the actuator 1.

As can be seen in FIG. 8, once the releasable clamp 10 is placed in the first state, with the pawl or pawls 5 retracted, the releasable clamp 10 may be inserted through the aligned holes 50 and 51 in the accessory body 40 and the vehicle body 41. After insertion, the releasable clamp 10 may be switched in the second state, wherein the pawl or pawls 5 are extended from the protrusion 3, by applying an operating force to the actuator 1, such that the releasable clamp 10 transitions from the first state S1, to the intermediate state and to the second state S2 in which the sloping engagement surfaces 31b engage with the vehicle body 41, more specifically with at least a portion of the peripheral portion of the hole 51 and bring the vehicle body 41, the accessory body 40, and the compression surface 4 of the releasable clamp 10 into compressed relation. The degree of force with which the engagement surfaces 31b engage the releasable clamp 10 may be determined by factors such as the combined thicknesses of the accessory body 40 and the vehicle body 41, the biasing force of the connecting member 32, the force applied to the actuator 1, and so on.

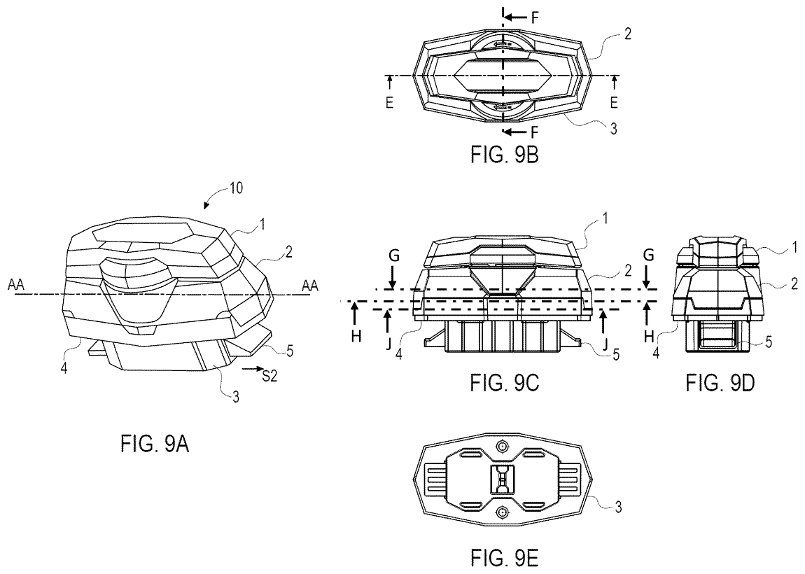

Various views of the releasable clamp 10, in the second state, wherein the pawl or pawls 5 are extended, are shown in FIG. 9A to FIG. 9E. To better understand the operation of the releasable clamp 10 in subsequent figures, several cross-sectional views are provided and described herein below. In the following figures, the illustrated cross sections may be represented as cross-sections taken along section line AA-AA shown in FIG. 9A for perspective side views, or along section line E-E shown in FIG. 9B for side views. It will be understood that as actuator 1 is moved in the various actuating positions shown in the subsequent figures, the cross section will nevertheless generally represents the cross-section along section line AA such that various cross-sectional views of the actuator 1 are shown in various actuating positions.

FIG. 10A and FIG. 10B illustrate views of the releasable clamp 10, such as after being inserted through the hole 50 in accessory body 40 and the hole 51 in the vehicle body 41, which are aligned, and in the second state wherein the pawl or pawls 5 are extended. More specifically, the releasable clamp 10 is shown in the second state S2 in which the sloping engagement face 31b is engaged with the peripheral portion (e.g. edge or edge surface) of the hole 51 of the vehicle body 41. It will be understood that in order to achieve the second state S2, the releasable clamp 10 is in the first state S1 or moved from the first state S1 to the intermediate state by applying a force to the actuator 1 such that the pawl or pawls 5 may be urged laterally into the extended position in which the pawl or pawls 5 are engaged with at least a portion of the peripheral portion of the hole 51 of the vehicle body 41. The force applied to the actuator 1, along with the biasing force of connecting member 32 may extend and hold the pawl or pawls 5 in the extended position from the protrusion 3, notwithstanding the total thickness to be clamped.

FIG. 10C to FIG. 10G illustrate additional views of the releasable clamp 10 and its components when the releasable clamp 10 is in the extended position.

Referring to FIG. 10E, when the actuator 1 is rotated from the first position to the second position, the coupler 1c drives the connecting member 32 away from the first axis A1 in a translational and rotational movement via the internal mechanism 30 that is operatively connected to the actuator 1 via the connecting pivot 1d. The connecting member 32 then drives the pawl 5 away from the first axis A1 in a translational movement guided by the guiding means 34 via the pawl pivot 5h. When the actuator 1 is rotated such that the coupler 1c and the connecting member 32 begin to create an over-center effect, the pawl pivot 5h moves away from the first axis A1 along the elongated cavity portion 5j, which activates the resilient member 33. When the actuator 1 is in the second position, the pawl 5 is moved away from the first axis A1 along the guiding means 34. The resilient member 33 provides a force that contributes to maintain the over-center effect that prevents unwanted release of the releasable clamp 10.

In some embodiments, as shown in FIG. 10E, the protrusion 3 can further have stopper(s) (e.g. tab(s), protrusion(s), bump(s), etc.) limiting the movement of certain components (e.g. rotation of the actuator 1 or the connecting member 32, etc.). This addition helps give feedback as to when the releasable clamp 10 is in the locked position or unlocked position. It can also prevent the mechanism to be damaged by excessive movement or force applied thereto.

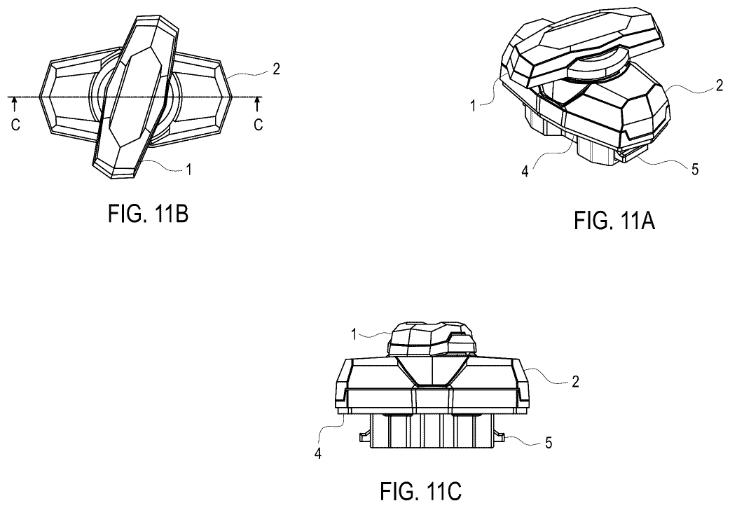

FIG. 11A to FIG. 11C illustrate the releasable clamp 10 in an intermediate state, e.g. to a partially extended/retracted position, such as when the pawl or pawls 5 are being moved from the first state S1 to the second state S2, or from the second state S2 to the first state S1. It will be understood that in order to achieve the intermediate state between the first state S1 and the second state S2, the releasable clamp 10 is operated by applying a force to the actuator 1 in a direction R1 or R2. The actuator 1 may be operated such that the pawl or pawls 5 are urged laterally from the extended position, in which the pawl or pawls 5 are fully engaged with the aligned openings, toward the retracted position in which the pawl or pawls 5 disengage from the aligned openings. Alternatively, the actuator 1 may be operated such that the pawl or pawls 5 may be urged laterally from the retracted position, in which the pawl or pawls 5 are fully retracted, toward the extended position in which the pawl or pawls 5 move toward engagement.

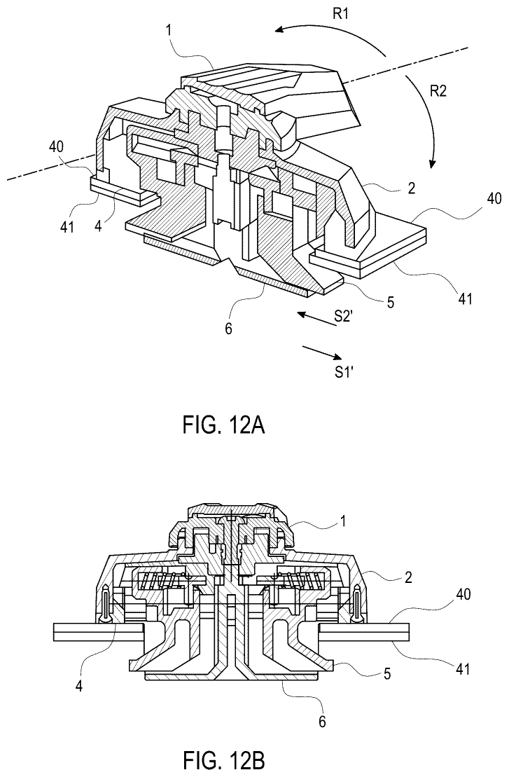

FIG. 12A and FIG. 12B illustrate views of the releasable clamp 10, in an intermediate state S1′ such as after being placed in the first state S1 and being inserted through the hole 50 in accessory body 40 and the hole 51 in the vehicle body 41, which are aligned, and operating the actuator 1 in the direction R1 or R2 such that the pawl or pawls 5 begin to extend into the second state S2. The intermediate state illustrated in FIG. 12A and FIG. 12B may also reflect an intermediate state S2′ after operating the actuator in the direction R1 or R2 to disengage from the second state S2, in which the actuator 1 is operated in the direction R1 or R2 such that the pawl or pawls 5 begin to retract.

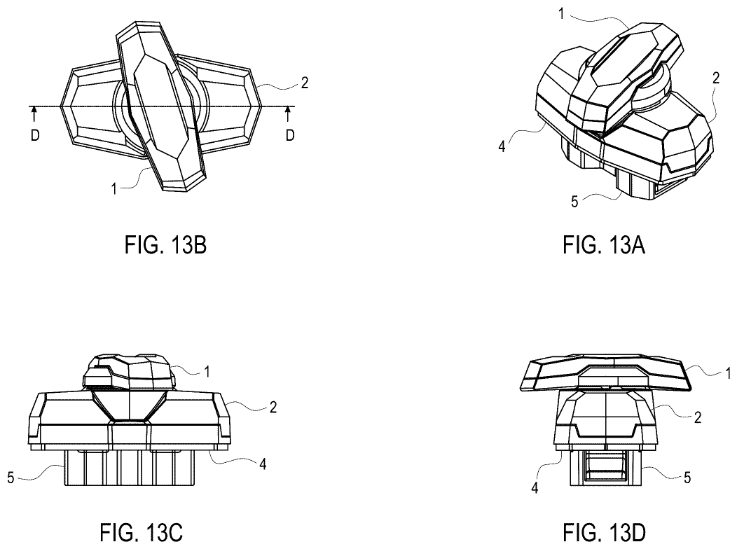

FIG. 13A through FIG. 13D illustrate various views the releasable clamp 10 in the first state S1 in which the pawl or pawls 5 are fully retracted into the protrusion 3. It will be understood that in order to achieve the first state S1, the releasable clamp 10 is operated by applying a force to the actuator 1 in one of the directions R1 or R2 such that the pawl or pawls 5 may be urged laterally into the retracted position in which the pawl or pawls 5 are disengaged. It will be further understood that in order to insert the releasable clamp 10 into operating position, i.e. through holes 50 and 51 of the accessory and vehicle bodies, respectively, the releasable clamp 10 should be in the first state S1 and the holes 50 and 51 should be aligned or in a properly registered position.

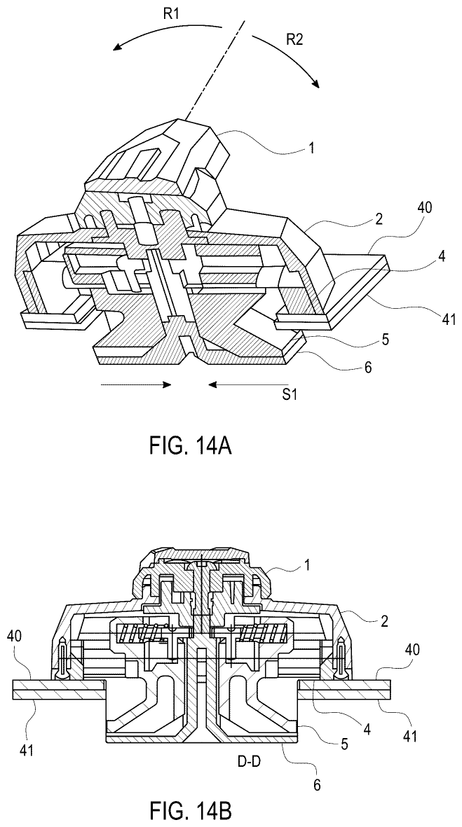

FIG. 14A and FIG. 14B illustrate views of the releasable clamp 10, in the fully retracted state S1 such as after being placed in the first state S1 and being inserted through the hole 50 in accessory body 40 and the hole 51 in the vehicle body 41, which are aligned, and operating the actuator 1 in the direction R1 or R2 such that the pawl or pawls 5 begin to extend outwardly toward the second state S2.

### Method

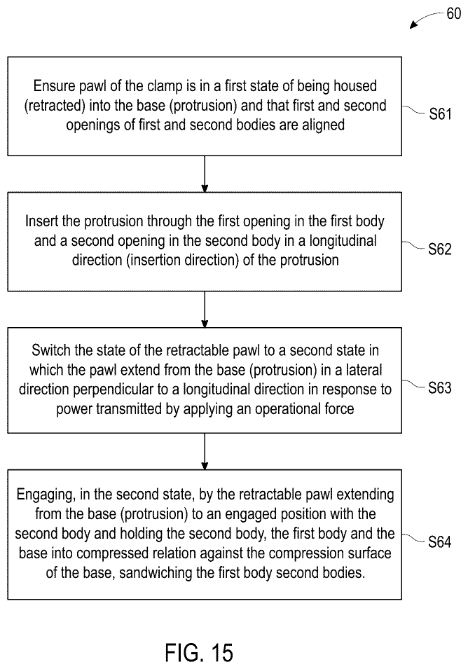

In accordance with one or more embodiments, a method 60 of releasably clamping a first body to a second body is provided as illustrated in FIG. 15. The method may be practiced, for example, using the releasable clamp 10 as described herein above. In a first step S61, the pawl or pawls of the exemplary releasable clamp should be ensured as being in the first state, a state of being housed (retracted) into the base (protrusion) of the clamp. The first and second openings of the respective first and second bodies to be clamped should be brought into alignment or registered. In a second step S62, a protrusion of the releasable clamp is inserted through the first and second openings in a longitudinal direction (insertion direction) of the protrusion. When the releasable clamp is fully seated into the openings, the clamping surface of the releasable clamp is resting on an outer surface of the first body.

In a third step S63, the state of the pawl or pawls is switched to the second state in which the pawl or pawls extend from the base (protrusion) in a lateral direction, perpendicular to the longitudinal direction. The second state may be achieved in response to power transmitted by applying an operational force to an actuator of the clamp. In a fourth step S64, as the second state is achieved, and the pawl or pawls move to an engaged position, the second body, the first body and the base are brought into a compressed relation against a compression surface of the releasable clamp that is in contact with a surface of the first body such that the first body and the second body are sandwiched between the compression surface and the sloping engagement surfaces of the pawl or pawls.

### Effects

One or more embodiments of the releasable clamp 10 and method of releasably joining first and second body described herein provide distinct advantages. For example, due to the sloping engagement surfaces of the pawl or pawls 5, varying thicknesses of the first body and the second body may be taken into account without the need for specialized designs for each combination of body thicknesses. To the contrary, one or more embodiments as described herein may accommodate a wide variety of thicknesses and still provide reliable and rapid clamping and releasing.

More precisely, when the sloping engagement surface 31b comes into contact with a body portion, more specifically a peripheral portion of the opening of the body portion as will be further described below, (e.g. a vehicle body), to which another body (e.g. an accessory body) is being joined by the releasable clamp 10, when the actuator 1 is rotated from the first position to the second position, the internal mechanism 30 drives the pawl 5 away from the first axis A1 in a translational movement guided by the guiding means 34 via the pawl pivot 5h, such that the pawl pivot 5h moves away from the first axis A1 along the elongated cavity portion 5j, which activates the resilient member 33. When the actuator 1 is in the second position, the pawl 5 is moved away from the first axis A1 along the guiding means 34 in locked position. In other words, the locking process (i.e. movement of the pawl pivot, compression of the resilient member, creation of an over-center effect, etc.) of the releasable clamp 10 begins when the sloping engagement surface 31b comes into contact with a peripheral portion of the opening into which the releasable clamp 10 is engaged, notwithstanding the thickness of the body portion to clamp. It can thud be said that the releasable clamp 10 is configured to provide a clamping force adaptative to various thicknesses of body portions to be joined, thanks to the internal mechanism and the sloping engaging portion, among other things.

The present technology may include other embodiments or modifications in addition to one or more embodiments and modifications described herein without departing from the spirit of the invention. The one or more embodiments and modifications described herein are to be considered illustrative and exemplary, and not restrictive, exhausting or limiting in nature. The scope of the present technology is indicated by the appended claims rather than by the foregoing description. Accordingly, configurations considered to fall within equivalent arrangements of the claims are intended to be embraced within the proper scope of the invention.

What is claimed is:

1. A clamp for releasably joining a first body to a second body, the clamp being insertable through a first opening in the first body and a second opening in the second body aligned with the first opening, the clamp comprising:
a base comprising a compression surface that faces the first body and is compressible around a periphery of the first opening, and a protrusion extending in a longitudinal direction from the base, the protrusion insertable through the first and second openings and connectable to the second body;
an actuator connected to the base; and
a retractable pawl assembly housed in the base, the pawl assembly having a pawl or pawls extendable from the protrusion of the base in a lateral direction perpendicular to the longitudinal direction, the pawl assembly operatively coupled to the actuator, wherein
the pawl or pawls are retracted into the protrusion in a disengaged position by operation of the actuator through a force applied to the actuator, and
the pawl or pawls are extended from the protrusion of the base to an engaged position to engage the second body and to hold the second body, the first body and the base into compressed relation against the compression surface by force applied to the actuator.

2. The clamp according to claim 1, wherein each of the pawl or pawls comprises a cam surface that slopes to widen in a direction away from the base to variably engage with the second body.

3. The clamp according to claim 2, wherein the cam surface extends to variably engage the second body to hold the second body, the first body and the base into compressed relation against the compression surface.

4. The clamp according to claim 1, wherein the base further comprises resilient members coupled to the actuator at one end and extending laterally from a central axis of the base in the longitudinal direction, the resilient members pressing against the pawl or pawls at an other end to urge the pawl or pawls to extend laterally outwardly by operation of the actuator.

5. The clamp according to claim 1, wherein the pawl or pawls extend from and retract into the protrusion in a direction orthogonal to the rotation axis.

6. A clamp for releasably joining a first body to a second body, the clamp being insertable through a first opening in the first body and a second opening in the second body aligned with the first opening, the clamp comprising:
a base having a compression surface;
a protrusion projecting from the base in a longitudinal direction perpendicular to the compression surface relative to the base;
a retractable pawl that can be switched between a first state of being housed in the protrusion and a second state of extending from the protrusion in a lateral direction perpendicular to the longitudinal direction; and
an actuator that transmits power to the retractable pawl for switching the state of the retractable pawl from one of the first and second states to the other one of the first and second states in response to an operation force; wherein
the retractable pawl comprises a surface facing the base and that slopes away from the compression surface in the longitudinal direction.

7. The clamp according to claim 6, wherein the surface of the pawl widens in a lateral direction away from the base.

8. The clamp according to claim 7, wherein the surface of the pawl widens in the lateral direction away from the base to engage with the opening of the second body to hold the second body against the first body, the first body and the base into compressed relation against the compression surface.

9. The clamp according to claim 6, wherein the base further comprises a resilient member operatively coupled to the pawl at one end and extending laterally from the protrusion to press against the pawl at an other end to urge the pawl outwardly by the operational force.

10. The clamp according to claim 6, wherein the laterally retractable pawl extends laterally from and retracts laterally into the protrusion in a direction orthogonal to the longitudinal direction.

11. A method of releasably joining a first body to a second body using a clamp comprising: a base having a compression surface; a protrusion projecting from the base in a longitudinal direction perpendicular to the compression surface relative to the base; a retractable pawl retractable into the base and comprising a surface; and an actuator that transmits power to the retractable pawl, the method comprising:
inserting, with the retractable pawl in a first state of being retracted, the protrusion through a first opening in the first body and a second opening in the second body aligned with the first opening; and
switching the state of the retractable pawl to a second state of being extended from the base in a lateral direction perpendicular to the longitudinal direction in response to the power transmitted by applying an operational force applied to the actuator; wherein
in the second state, the retractable pawl extends from the base to an engaged position to engage the second body and to hold the second body, the first body and the base into compressed relation against the compression surface.

12. The method of claim 11, further comprising switching the state of the retractable pawl from the second state in which the second body, the first body and the base are held in compressed relation against the compression surface to the first state in which the second body, the first body and the base are released from compressed relation such that the clamp is removed.

13. An actuator for engaging a releasable clamp for releasably joining a first body to a second body, the releasable clamp being insertable through a first opening in the first body and a second opening in the second body aligned with the first opening, the releasable clamp comprising: a base; a protrusion; a retractable pawl extendable and retractable along an engagement axis, the retractable pawl capable of being switched between a first state of being housed in the protrusion and a second state of extending from the protrusion, the actuator comprising:
an actuator body configured to be selectively rotatable about a first axis extending longitudinally, the actuator body extending along a second axis perpendicular to the first axis, the actuator body configured to activate operation of the releasable clamp under an activation force;
a mounting portion operatively coupled to the base;
a coupler operatively coupled to the actuator and extending radially from the first axis; and
an internal mechanism operatively coupled to the actuator and the retractable pawl, the internal mechanism configured to convert the rotational movement of the actuator under the activation force about the first axis into a translational movement of the retractable pawl along the engagement axis, the internal mechanism comprising:
a connecting member pivotally connected to the coupler about a connecting pivot defining a connecting pivot axis extending parallel to the first axis,
a resilient member provided between the connecting member and the pawl to bias the pawl away from the first axis, and
a guiding member slidingly connected to and guiding the connecting member along the engagement axis.

14. The actuator according to claim 13, wherein
the actuator is configured to transmit the activation force to the retractable pawl through the internal mechanism, the actuator for switching the state of the retractable pawl from one of a first state in which the pawl is extended and a second state in which the pawl is retracted to the other one of the first state and the second state in response to the activation force; and
the retractable pawl comprises an engagement surface facing the base and that slopes away in the longitudinal direction from a compression surface of the base.

15. The actuator according to claim 14, wherein the engagement surface of the retractable pawl widens in a lateral direction away from the base.

16. The actuator according to claim 14, wherein
when the engagement surface comes into contact with a peripheral portion of the first and second openings of the first and second bodies, respectively, the releasable clamp provides a clamping force adaptative to various thicknesses among the first and second bodies to be joined.

17. The actuator according to claim 14, wherein when the activation force is applied to the actuator such that the retractable pawl is in the second state, the resilient member applies the biasing force so as to maintain an over-center effect between the coupler and the connecting member that prevents unwanted release of the releasable clamp.

18. The actuator according to any one of claim 13, wherein the actuator is operable without use of a tool.

19. A releasable clamp for releasably joining a first body to a second body, the releasable clamp being insertable through a first opening in the first body and a second opening in the second body aligned with the first opening, the releasable clamp comprising:
a base;
a protrusion;
a retractable pawl extendable and retractable along an engagement axis, the retractable pawl capable of being switched between a first state of being housed in the protrusion and a second state of extending from the protrusion; and
an actuator in accordance with claim 13, wherein the actuator is configured to transmit the activation force to the retractable pawl through the internal mechanism so as to switch the state of the retractable pawl from one of the first state and the second state to the other one of the first state and the second state in response to the activation force.
